(19) United States
(12) Patent Application Publication
(10) Pub. No.: US 2017/0107362 A1
(43) Pub. Date: Apr. 20, 2017

(54) RUBBER COMPOSITION AND PNEUMATIC TIRE USING SAME

(71) Applicant: THE YOKOHAMA RUBBER CO., LTD., MINATO-KU, TOKYO (JP)

(72) Inventor: Yusuke TANABE, HIRATSUKA-CITY, KANAGAWA (JP)

(21) Appl. No.: 15/129,151

(22) PCT Filed: Mar. 26, 2015
(86) PCT No.: PCT/JP2015/059405

§ 371 Date: Sep. 26, 2016

(30) Foreign Application Priority Data
Mar. 27, 2014 (JP) 2014-067050

(51) Int. Cl. C08L 9/08

(52) U.S. Cl. CPC C08L 9/08; C08L 2205/02

(57) ABSTRACT

An object of the present invention is to provide a rubber composition that is excellent in terms of the Payne effect and has high modulus, while maintaining high rubber hardness; and a pneumatic tire formed from this rubber composition. The present invention provides: a rubber composition containing, per 100 parts by mass of a diene rubber, from 1 to 100 parts by mass of carbon black and/or from 10 to 150 parts by mass of a white filler, from 0.1 to 10 parts by mass of a thiol compound having a mercapto group and a sulfonate group, and from 1 to 50 parts by mass of a sulfur-containing compound (except the thiol compound); and a pneumatic tire formed from this rubber composition.

### TECHNICAL FIELD

The present invention relates to a rubber composition and a pneumatic tire formed from such a rubber composition.

### BACKGROUND ART

Conventionally, rubber compositions containing a diene rubber and a filler have been used in tires or the like. To enhance dispersion of fillers (e.g. white fillers such as silica) in such rubber compositions, use of sulfur-containing compound such as polysulfide-based silane coupling agents has been known (e.g. Patent Document 1).

### CITATION LIST

### Patent Literature

Patent Document 1: Japanese Unexamined Patent Application Publication No. 2009-286897A

### SUMMARY OF INVENTION

### Technical Problem

However, when dispersion of a filler is enhanced and Payne effect is reduced for a rubber composition containing a white filler and a sulfur-containing compound, the hardness and/or modulus of the resulting rubber may be deteriorated. Therefore, the inventor of the present invention has found that both the modulus and the Payne effect need to be enhanced at the same time while high rubber hardness is maintained.

Therefore, an object of the present invention is to provide a rubber composition that is excellent in terms of the Payne effect and has high modulus, while maintaining high rubber hardness; and a pneumatic tire formed from such a rubber composition.

### Solution to Problem

As a result of diligent research to solve the above problem, the inventor of the present invention has found that a rubber composition that is excellent in terms of the Payne effect and has high modulus, while maintaining high rubber hardness, can be obtained by using a particular amount of a thiol compound having a mercapto group and a sulfonate group to a rubber composition containing particular amounts of a diene rubber, carbon black and/or a white filler, and a sulfur-containing compound, and thus completed the present invention.

That is, the present invention provides the following rubber composition and a pneumatic tire formed from such a rubber composition.

1. A rubber composition containing: per 100 parts by mass of a diene rubber, at least one selected from the group consisting of from 1 to 100 parts by mass of carbon black and from 10 to 150 parts by mass of a white filler, from 0.1 to 10 parts by mass of a thiol compound having a mercapto group and a sulfonate group, and from 1 to 50 parts by mass of a sulfur-containing compound (except the thiol compound).

2. The rubber composition according to 1 described above, where the thiol compound is a compound represented by Formula (1) below:

HS-A-SO₃X (1)

In the formula, A is a hydrocarbon group having from 1 to 20 carbons, an oxyalkylene group having from 1 to 20 carbons, or a combination of these, and A may have a substituent; and X is an alkali metal.

3. The rubber composition according to 1 or 2 described above, where the sulfur-containing compound is at least one type selected from the group consisting of sulfur, sulfur-containing silane coupling agents, and sulfur-containing vulcanization accelerators.

4. The rubber composition according to any one of 1 to 3 described above, where the white filler is silica, the sulfur-containing compound contains at least a sulfur-containing silane coupling agent, and an amount of the sulfur-containing silane coupling agent is from 1 to 15 parts by mass per 100 parts by mass of the diene rubber.

5. A pneumatic tire produced by using the rubber composition described in any one of 1 to 4 described above.

6. The pneumatic tire according to 5 described above, where the rubber composition is used in at least one type selected from the group consisting of a cap tread, sidewall, belt, inner liner, carcass, and bead.

### Advantageous Effects of Invention

The rubber composition of the present invention and the pneumatic tire of the present invention are excellent in terms of the Payne effect and have high modulus while high rubber hardness is maintained.

### BRIEF DESCRIPTION OF THE DRAWINGS

FIG. 1 is a cross-sectional view schematically illustrating a partial cross section in the meridian direction of a tire in an example of an embodiment of the pneumatic tire of the present invention.

### DESCRIPTION OF EMBODIMENT

The present invention is described in detail below.

The rubber composition of the present invention is:

a rubber composition containing: per 100 parts by mass of a diene rubber, from 1 to 100 parts by mass of carbon black and/or from 10 to 150 parts by mass of a white filler, from 0.1 to 10 parts by mass of a thiol compound having a mercapto group and a sulfonate group, and from 1 to 50 parts by mass of a sulfur-containing compound (except the thiol compound).

In the present invention, a rubber composition that is excellent in terms of the Payne effect and has high modulus, while maintaining high rubber hardness, can be obtained by allowing a thiol compound having a mercapto group and a sulfonate group in a molecule to be contained. Note that, in the present invention, “modulus” include, for example, modulus at room temperature and/or high temperatures. Furthermore, in the specification of the present application, the case where at least one of the effects on rubber hardness, the Payne effect, and modulus is superior will be also described as “exhibit superior effect of the present invention” hereinafter.

The mercapto group contained in the thiol compound can react with a diene rubber, and it is thus conceived that high modulus can be achieved.

The sulfonate group contained in the thiol compound can strongly interact with a filler (e.g. silica). Therefore, it is conceived that the sulfonate group can react with the filler more rapidly than a silane coupling agent does, and can form aggregates of the filler in a suitable size, thereby exhibiting excellent effect in terms of the Payne effect. Furthermore, since the sulfonate group has lower acidity than that of sulfonic acid group (sulfo group), it is conceived that the thiol compound contained in the present invention, for example, is unlikely to cause gelling of a diene rubber, accelerates coupling of the diene rubber, maintains suitably high crosslinking density, and contributes to high modulus, compared to a compound having a mercapto group and a sulfonic acid group. Note that the mechanism described above is a deduction by the present inventors, and, even if the mechanism differs from the above, such mechanisms are within the scope of the present invention.

The diene rubber contained in the rubber composition of the present invention is not particularly limited as long as the rubber is sulfur-crosslinkable. Specific examples include natural rubber (NR), isoprene rubber (IR), butadiene rubber (BR), aromatic vinyl-conjugated diene copolymer rubber, acrylonitrile-butadiene copolymer rubber (NBR), butyl rubber (IIR), butyl halide rubber (Br—IIR, Cl—IIR), and chloroprene rubber (CR).

In the present invention, it is preferable to use an aromatic vinyl-conjugated diene copolymer rubber as the diene rubber from the perspective of achieving excellent low heat build-up.

Examples of the aromatic vinyl-conjugated diene copolymer rubbers include styrene-butadiene copolymer rubber (SBR) and styrene-isoprene copolymer rubber. Of these, styrene-butadiene copolymer rubber (SBR) is preferable from the perspective of achieving excellent wear resistance.

The weight average molecular weight of the diene rubber is preferably from 200,000 to 2,500,000 from the perspective of exhibiting superior effect of the present invention and excellent low heat build-up. In the present invention, the weight average molecular weight (Mw) of the diene rubber is measured by gel permeation chromatography (GPC) on the basis of standard polystyrene using tetrahydrofuran as a solvent.

There is no particular limitation on the production of the diene rubber. Examples thereof include conventionally known methods.

A single diene rubber can be used, or a combination of two or more types can be used.

The combination of diene rubbers is preferably a combination of SBR and BR from the perspective of exhibiting excellent wear resistance. The quantitative ratio of the SBR and the BR (mass ratio, SBR:BR) can be set to 50 to 99:50 to 1.

The carbon black that can be contained in the rubber composition of the present invention is not particularly limited. Examples thereof include conventionally known carbon black. A single carbon black can be used or a combination of two or more carbon blacks can be used.

In the present invention, the amount of carbon black is from 1 to 100 parts by mass per 100 parts by mass of the diene rubber. The amount of carbon black is preferably from 3 to 90 parts by mass, and more preferably from 5 to 80 parts by mass, per 100 parts by mass of the diene rubber from the perspective of exhibiting superior effect of the present invention and excellent low heat build-up.

The white filler that can be contained in the rubber composition of the present invention is not particularly limited. Examples include silica, calcium carbonate, clay, and talc. An example of a preferable form of the white filler is silica.

The silica contained in the rubber composition of the present invention is not particularly limited. It can be any conventional, publicly known silica that is blended in rubber compositions used in tires and the like.

Examples of silicas include wet silica, dry silica, fumed silica, and diatomaceous earth. The silica preferably contains a wet silica from the perspective of the reinforcement of the rubber.

The silica preferably has a cetyltrimethylammonium bromide (CTAB) adsorption specific surface area of 100 to 300 m²/g and more preferably 140 to 200 m²/g from the perspective of exhibiting superior effect of the present invention and excellent low heat build-up.

Here, the CTAB adsorption specific surface area is an alternative characteristic of the surface area of the silica that can be utilized for adsorption to the silane coupling agent. The CTAB adsorption specific surface area is a value determined by measuring the amount of CTAB adsorption to the silica surface in accordance with JIS K 6217-3:2001 “Part 3: How to Determine Specific Surface Area—CTAB Adsorption Method”.

The white filler can be used alone or as a combination of two or more types of white fillers.

When the white filler is silica, an example of a preferable form of the sulfur-containing compound is a sulfur-containing compound containing at least a sulfur-containing silane coupling agent from the perspective of exhibiting superior effect of the present invention and excellent low heat build-up.

In the present invention, the content of the white filler is from 10 to 150 parts by mass per 100 parts by mass of the diene rubber. Furthermore, from the perspective of exhibiting superior effect of the present invention and excellent low heat build-up, the content of the white filler is preferably from 20 to 120 parts by mass, and more preferably from 40 to 100 parts by mass, per 100 parts by mass of the diene rubber.

The sulfur-containing compound contained in the present invention is not particularly limited as long as the compound has a sulfur atom. The sulfur-containing compound may be at least one type selected from the group consisting of sulfur, sulfur-containing silane coupling agents, and sulfur-containing vulcanization accelerators, for example. Note that, in the present invention, the sulfur-containing compound does not contain a thiol compound described below.

The sulfur as the sulfur-containing compound is not particularly limited. Examples thereof include conventionally known sulfur.

The sulfur-containing silane coupling agent is not particularly limited as long as it is a silane coupling agent having a sulfur atom. Examples thereof include polysulfide-based silane coupling agents such as bis(3-triethoxysilylpropyl) tetrasulfide, 3-trimethoxysilylpropyl benzothiazole tetrasulfide, bis(3-triethoxysilylpropyl) disulfide; mercapto-based silane coupling agents such as γ-mercaptopropylmethyldimethoxysilane, γ-mercaptopropyltrimethoxysilane, 3-[ethoxybis (3,6,9,12,15-pentaoxaoctacosan-1-yloxy) silyl]-1-propanethiol (Si 363, manufactured by Evonik Degussa); thiocarboxylate-based silane coupling agents such as 3-octanoylthiopropyltriethoxysilane; and thiocyanate-based silane coupling agents such as 3-thiocyanatepropyltriethoxysilane.

Of these, from the perspective of exhibiting superior effect of the present invention and excellent low heat build-up, polysulfide-based silane coupling agents are preferable, and bis-(3-triethoxysilylpropyl) tetrasulfide and bis(3-triethoxysilylpropyl) disulfide are more preferable.

The sulfur-containing vulcanization accelerator is not particularly limited as long as it is a vulcanization accelerator that has sulfur atoms and can be used in a rubber composition. Here, sulfur-containing vulcanization accelerators are assumed to include sulfur-containing vulcanization acceleration aids. Examples of the sulfur-containing vulcanization accelerators include thiuram compounds such as tetramethylthiuram disulfide and tetramethylthiuram monosulfide; dithiocarbamates such as zinc dimethyldithiocarbamate; thiazole compounds such as 2-mercaptobenzothiazole and dibenzothiazyl disulfide; and sulfenamide compounds such as N-cyclohexyl-2-benzothiazole sulfenamide and N-t-butyl-2-benzothiazole sulfenamide.

Of these, N-cyclohexyl-2-benzothiazolyl sulfenamide and N,N-dicyclohexyl-2-benzothiazolyl sulfenamide are preferable from the perspective of exhibiting superior effect of the present invention and excellent low heat build-up.

The sulfur-containing compound can be used alone or as a combination of two or more types.

In the present invention, the amount of the sulfur-containing compound is from 1 to 50 parts by mass per 100 parts by mass of the diene rubber. The amount of the sulfur-containing compound is preferably from 1.5 to 25 parts by mass, more preferably from 2 to 20 parts by mass, and even more preferably from 5 to 15 parts by mass, per 100 parts by mass of the diene rubber from the perspective of exhibiting superior effect of the present invention and excellent low heat build-up.

The amount of sulfur is preferably from 0.1 to 10 parts by mass per 100 parts by mass of the diene rubber.

The amount of the sulfur-containing vulcanization accelerator is preferably from 0.1 to 10 parts by mass per 100 parts by mass of the diene rubber.

The amount of the sulfur-containing silane coupling agent is preferably from 1 to 15 parts by mass, more preferably from 3 to 12 parts by mass, and even more preferably from 4 to 10 parts by mass, per 100 parts by mass of the diene rubber from the perspective of exhibiting superior effect of the present invention and excellent low heat build-up.

The thiol compound contained in the rubber composition of the present invention is not particularly limited as long as the thiol compound is a compound having a mercapto group and a sulfonate group.

The number of mercapto group (—SH) contained in a molecule of the thiol compound is preferably from 1 to 3.

The number of sulfonate group (—SO₃X) contained in a molecule of the thiol compound is preferably from 1 to 3. The sulfonate group is represented by, for example, —SO₃X. X is preferably an alkali metal. Examples of the alkali metal include sodium and potassium.

The mercapto group and the sulfonate group can bond using an organic group. Examples of the organic group include hydrocarbon groups that may have a hetero atom like an oxygen atom, a nitrogen atom, or a sulfur atom. Examples of the hydrocarbon group include aliphatic hydrocarbon groups, alicyclic hydrocarbon groups, aromatic hydrocarbon groups, and combinations thereof, and the hydrocarbon group may be either straight or branched, and may have a saturated bond. Specific examples thereof include a hydrocarbon group having from 1 to 20 carbons, an oxyalkylene group having from 1 to 20 carbons, or a combination of these, and these groups may have a substituent. Examples of the substituent include a hydroxy group, carboxyl group, cyano group, amino group, and halogen.

Examples of the hydrocarbon group having from 1 to 20 carbons that may have a substituent include alkylene groups such as a methylene group, ethylene group, propylene group, octylene group, decylene group, and dodecylene group; phenylene groups; and groups in which at least one hydrogen atom of these hydrocarbon groups is substituted with a substituent.

Examples of the oxyalkylene group having from 1 to 20 carbons that may have a substituent include —O—(CH₂)ₙ— (n is from 1 to 20); and groups in which at least one hydrogen atom of such an oxyalkylene group is substituted with a substituent.

Of these, the thiol compound is preferably a compound represented by Formula (1) below from the perspective of exhibiting superior effect of the present invention and excellent low heat build-up.

HS-A-SO₃X (1)

In the formula, A is a hydrocarbon group having from 1 to 20 carbons, an oxyalkylene group having from 1 to 20 carbons, or a combination of these, and A may have a substituent; and X is an alkali metal.

The hydrocarbon group having from 1 to 20 carbons that may have a substituent, oxyalkylene group having from 1 to 20 carbons that may have a substituent, and alkali metal are the same as described above.

Examples of the thiol compound include sodium 3-mercapto-1-propanesulfonate, potassium 3-mercapto-1-propanesulfonate, sodium 4-mercapto-1-butanesulfonate, and potassium 4-mercapto-1-butanesulfonate.

Of these, the thiol compound is preferably sodium 3-mercapto-1-propanesulfonate from the perspective of exhibiting superior effect of the present invention and excellent low heat build-up, and being readily available.

The thiol compound can be used alone or as a combination of two or more types. The production of the thiol compound is not particularly limited. Examples thereof include conventionally known production methods.

In the present invention, the amount of the thiol compound is from 0.1 to 10 parts by mass per 100 parts by mass of the diene rubber. Furthermore, from the perspective of exhibiting superior effect of the present invention and excellent low heat build-up, the amount of the thiol compound is preferably from 0.3 to 8 parts by mass, and more preferably from 0.5 to 5 parts by mass, per 100 parts by mass of the diene rubber.

The rubber composition of the present invention may further contain a silane coupling agent that does not contain sulfur.

Furthermore, when the white filler is silica, an example of a preferable form of the rubber composition of the present invention is a rubber composition further containing a silane coupling agent that does not contain sulfur.

The silane coupling agent that does not contain sulfur is not particularly limited. Examples thereof include aminosilane coupling agents, epoxysilane coupling agents, and hydroxysilane coupling agents.

The rubber composition of the present invention may further contain additives as necessary within a scope that does not inhibit the effect or purpose thereof.

Examples of the additive include various additives typically used in rubber compositions, such as zinc oxide, stearic acid, antiaging agents, processing aids, aroma oils, liquid polymers, terpene-based resins, thermosetting resins, vulcanizing agents other than sulfur, vulcanizing accelerators not having sulfur atoms, and vulcanizing accelerator aids not having sulfur atoms.

The production method of the rubber composition of the present invention is not particularly limited. A specific example is a method of mixing and kneading each of the components described above using a known method and apparatus (for example, a Banbury mixer, a kneader, a roller, or the like).

In addition, the rubber composition of the present invention can be vulcanized or crosslinked under conventional, publicly known vulcanizing or crosslinking conditions.

The rubber composition of the present invention can be used, for example, in a tire, a belt, a hose, or the like.

The pneumatic tire of the present invention will be described hereinafter.

The pneumatic tire of the present invention is a pneumatic tire that is produced by using the rubber composition of the present invention. The rubber composition used in the pneumatic tire of the present invention is not particularly limited as long as it is the rubber composition of the present invention.

In the pneumatic tire of the present invention, the rubber composition is preferably used in at least one type selected from the group consisting of a cap tread, sidewall, belt, inner liner, carcass, and bead.

The pneumatic tire of the present invention will be described hereafter with reference to the attached drawings. The pneumatic tire of the present invention is not limited to the accompanying drawings.

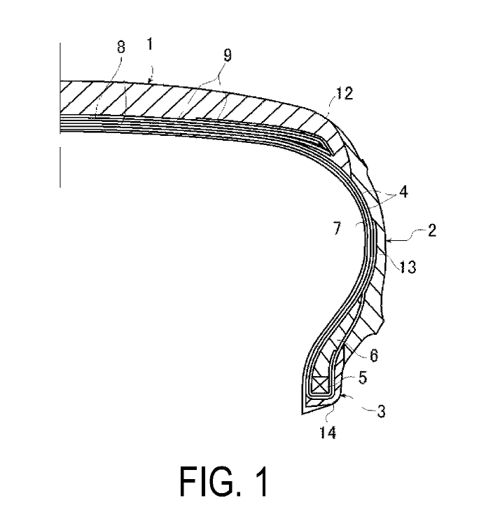

FIG. 1 is a cross-sectional view schematically illustrating a partial cross-section in the meridian direction of a tire in an example of an embodiment of the pneumatic tire of the present invention. In FIG. 1, reference numeral 1 is a cap tread, reference numeral 2 is a side wall, and reference numeral 3 is a bead.

In FIG. 1, two layers of a carcass 4, formed by arranging reinforcing cords extending in a tire circumferential direction at a predetermined pitch and embedding these reinforcing cords in a rubber layer, are disposed extending between left and right beads 3. Both ends of the carcass 4 are made to sandwich a bead filler 6 and are folded back around a bead core 5 that is embedded in the beads 3 in a tire axial direction from the inside to the outside. An inner liner 7 is disposed inward of the carcass 4. Two layers of a belt 8, formed by arranging reinforcing cords extending inclined to the tire circumferential direction in the tire axial direction at a predetermined pitch and embedding these reinforcing cords in a rubber layer, are disposed on an outer circumferential side of the carcass 4 of the cap tread 1. The reinforcing cords of the two layers of the belt 8 cross interlaminarly so that the incline directions with respect to the tire circumferential direction are opposite each other. A belt cover 9 is disposed on the outer circumferential side of the belt 8. The cap tread 1 is formed from a cap tread rubber layer 12 on the outer circumferential side of the belt cover 9. A side rubber layer 13 is disposed outward of the carcass 4 of each side wall 2, and a rim cushion rubber layer 14 is provided outward of the portion of the carcass 4 that is folded back around each of the beads 3.

The pneumatic tire of the present invention is not particularly limited with the exception that the rubber composition of the present invention is used for a pneumatic tire, and, for example, the tire can be produced in accordance with a conventionally known method. In addition to ordinary air or air with an adjusted oxygen partial pressure, inert gasses such as nitrogen, argon, and helium can be used as the gas with which the tire is filled.

### EXAMPLES

The present invention will be described below by means of examples. The present invention is not limited to such working examples.

### Production of Unvulcanized Rubber Composition

According to the composition (part by mass) shown in Table 1, the components other than the vulcanization components (sulfur-containing vulcanization accelerator, vulcanization accelerator, or sulfur) were kneaded for 5 minutes in a 1.7-liter sealed Banbury mixer. The composition was then discharged from the mixer and cooled to room temperature. Next, an unvulcanized rubber composition was obtained by placing the rubber composition in an open roll, adding the vulcanization components, and kneading the mixture.

### Production of Vulcanized Rubber

The unvulcanized rubber composition produced as described above was press-vulcanized for 20 minutes at 160° C. in a predetermined die to produce a vulcanized rubber.

### Evaluation

The physical properties of the unvulcanized rubber composition and the vulcanized rubber produced as described above were measured by the test methods described below. The results are shown in Table 1. The results were shown as index values, with the value of Comparative Example 1 expressed as 100.

### Bound Rubber

In a metal mesh basket, 0.5 g of an unvulcanized rubber composition was placed, immersed in 300 mL of toluene at room temperature for 72 hours, and then taken out and dried. By measuring the mass of the sample, the amount of the bound rubber was calculated based on the formula below.

Amount of bound rubber=[(sample mass after being immersed in toluene and dried)−(mass of carbon black and/or silica)]/(mass of rubber component)

Note that, when a combination of carbon black and silica is used, the mass of carbon black and/or silica is the total amount of these in the formula above.

A larger index value of bound rubber indicates greater amount of bound rubber (rubber reacted with carbon black and/or silica), and indicates that aggregation of the carbon black and/or the silica is prevented, thereby enhancing the dispersibility of the carbon black and/or the silica after the mixing.

### Payne Effect

Using the vulcanized rubber produced as described above, the strain shear stress G′ (0.56%) at a strain of 0.56% and the strain shear stress G′ (100%) at a strain of 100% were measured in accordance with ASTM D6204 using the RPA 2000 (strain shear stress measurement instrument, manufactured by Alpha Technologies). The difference (absolute value) between G′ (0.56%) and G′ (100%) was calculated.

A smaller index value indicates better dispersibility of silica caused by suppressing the reduction in the Payne effect.

Hardness (20° C.): In accordance with JIS K 6253, hardness (HS) was measured under the condition at 20° C. (JIS hardness A). A larger index value indicates higher rubber hardness, which is preferable.

### Measurement of Modulus

A JIS No. 3 dumbbell-shaped test piece was punched out from the vulcanized rubber produced as described above, and a tensile test was performed at a tensile speed of 500 mm/min in accordance with JIS K 6251. The modulus (M100 at room temperature) of the test piece was measured under the condition at 20° C. Furthermore, the modulus (M100 at high temperature) was measured similarly to the measurement of M100 at room temperature except for changing the condition to at 100° C.

A larger index value indicates better modulus and higher crosslinking density.

### Measurement of Tan δ (60° C.)

The value of tan δ (60° C.) was measured for the vulcanized rubber using a viscoelastic spectrometer manufactured by Iwamoto Seisakusho at an elongation deformation distortion factor of 10±2%, a vibration frequency of 20 Hz, and a temperature of 60° C.

Smaller index values indicate reduced heat build-up.

TABLE 1

| | | Working | | |
|---|---|---|---|---|
| | Comparative | Examples | | |
| Compounded amount (phr) | Example 1 | 1 | 2 | 3 |
| E-SBR | 80 | 80 | 80 | 80 |
| BR | 20 | 20 | 20 | 20 |
| Thiol compound | | 1 | 3 | 5 |
| γ-Mercaptopropyltrimethoxysilane | | | | |
| Silica | 50 | 50 | 50 | 50 |
| Carbon black | 5 | 5 | 5 | 5 |
| Zinc oxide | 3 | 3 | 3 | 3 |
| Stearic acid | 1 | 1 | 1 | 1 |
| Anti-aging agent | 1 | 1 | 1 | 1 |
| Sulfur-containing silane coupling | 4 | 4 | 4 | 4 |
| agent | | | | |
| Oil | 6 | 6 | 6 | 6 |
| Sulfur | 2 | 2 | 2 | 2 |
| Sulfur-containing vulcanization | 1 | 1 | 1 | 1 |
| accelerator (CZ) | | | | |
| Vulcanization accelerator (DPG) | 0.5 | 0.5 | 0.5 | 0.5 |

Physical Properties of unvulcanized product

| | | | | |
|---|---|---|---|---|
| Bound rubber | 100 | 132 | 168 | 178 |

Physical Properties of vulcanized product

| | | | | |
|---|---|---|---|---|
| Payne effect ΔG′ | 100 | 59 | 35 | 35 |
| Hardness (20° C.) | 100 | 99 | 100 | 99 |
| M100 at room temperature | 100 | 110 | 122 | 178 |
| M100 at high temperature | 100 | 125 | 183 | 232 |
| tanδ (60° C.) | 100 | 120 | 100 | 91 |

| | Comparative | Comparative |
|---|---|---|
| Compounded amount (phr) | Example 2 | Example 3 |
| E-SBR | 80 | 80 |
| BR | 20 | 20 |
| Thiol compound | 12 | |
| γ-Mercaptopropyltrimethoxysilane | | 5 |
| Silica | 50 | 50 |
| Carbon black | 5 | 5 |
| Zinc oxide | 3 | 3 |
| Stearic acid | 1 | 1 |
| Anti-aging agent | 1 | 1 |
| Sulfur-containing silane coupling | 4 | 4 |
| agent | | |
| Oil | 6 | 6 |
| Sulfur | 2 | 2 |
| Sulfur-containing vulcanization | 1 | 1 |
| accelerator (CZ) | | |
| Vulcanization accelerator (DPG) | 0.5 | 0.5 |

Physical Properties of unvulcanized product

| | | |
|---|---|---|
| Bound rubber | 215 | 116 |

Physical Properties of vulcanized product

| | | |
|---|---|---|
| Payne effect ΔG′ | 40 | 52 |
| Hardness (20° C.) | 91 | 89 |
| M100 at room temperature | 211 | 118 |
| M100 at high temperature | 242 | 111 |
| tanδ (60° C.) | 102 | 94 |

The details of each of the components shown in Table 1 are as follows.
E-SBR: emulsification-polymerized SBR; Nipol 1502, manufactured by Zeon Corporation
BR: Nipol BR1220, manufactured by Zeon Corporation
Thiol compound: sodium 3-mercapto-1-propanesulfonate; 3-MPS soda, manufactured by Asahi Chemical Co., Ltd.
γ-Mercaptopropyltrimethoxysilane: KBM-803, manufactured by Shin-Etsu Chemical Co., Ltd.
   Silica: wet silica, CTAB adsorption specific surface area: 170 m2/g; Nipsil AQ, manufactured by Japan Silica Corporation
Carbon black: Shoblack N339M, manufactured by Showa Cabot K.K.
Zinc oxide: Zinc White No. 3, manufactured by Seido Chemical Industry Co., Ltd.
Stearic acid: stearic acid, manufactured by Nippon Oil & Fats Co., Ltd.
Antiaging agent: antiaging agent (S-13); Antigen 6C, manufactured by Sumitomo Chemical Co., Ltd.
Sulfur-containing silane coupling agent: bis(triethoxysilylpropyl)tetrasulfide; Si69, manufactured by Evonik Degussa Corp.
Oil: Extract No. 4S, manufactured by Showa Shell Sekiyu K.K.
Sulfur: oil-treated sulfur, manufactured by Karuizawa Refinery Ltd.
Sulfur-containing vulcanization accelerator (CZ): N-cyclohexyl-2-benzothiazolyl sulfenamide; Sanceller CM-PO, manufactured by Sanshin Chemical Industry Co., Ltd.
Vulcanization accelerator (DPG): diphenylguanidine; Sanceller D-G, manufactured by Sanshin Chemical Industry Co., Ltd.

As is clear from the results shown in Table 1, with reference to Comparative Example 1 which did not contain a thiol compound, Comparative Example 3 which contained a mercapto-based silane coupling agent (free of sulfonate group) resulted in significant reduction in rubber hardness although the modulus was improved. Comparative Example 2, in which the amount of the thiol compound was greater than 10 parts by mass, resulted in significant reduction in rubber hardness and deterioration in low heat build-up.

In contrast, Working Examples 1 to 3 were excellent in terms of the Payne effect and exhibited high modulus while high rubber hardnesses were maintained.

When Working Examples 1 to 3 were compared, regarding physical properties of unvulcanized products, a greater amount of thiol compound resulted in a greater amount of bound rubber. It is conceived that this is because the thiol compound reacted with the carbon black and/or the silica at the same rate as and/or faster than the silane coupling agent did.

Furthermore, regarding physical properties of vulcanized product, a greater amount of the thiol compound resulted in a higher modulus and superior low heat build-up. When the modulus at high temperature and the modulus at room temperature were compared, a greater amount of the thiol compound resulted in more significant enhancement thereof.

### REFERENCE SIGNS LIST

1 Cap tread
2 Sidewall
3 Bead
4 Carcass
5 Bead core
6 Bead filler
7 Inner liner
8 Belt
9 Belt cover
12 Cap tread rubber layer
13 Side rubber layer
14 Rim cushion rubber layer

1. A rubber composition comprising: per 100 parts by mass of a diene rubber, at least one selected from the group consisting of from 1 to 100 parts by mass of carbon black and from 10 to 150 parts by mass of a white filler, from 0.1 to 10 parts by mass of a thiol compound having a mercapto group and a sulfonate group, and from 1 to 50 parts by mass of a sulfur-containing compound (except the thiol compound).

2. The rubber composition according to claim 1, wherein the thiol compound is a compound represented by Formula (1) below:
HS-A-SO₃X (1)
where, A is a hydrocarbon group having from 1 to 20 carbons, an oxyalkylene group having from 1 to 20 carbons, or a combination of these, and A may have a substituent; and X is an alkali metal.

3. The rubber composition according to claim 1, wherein the sulfur-containing compound is at least one type selected from the group consisting of sulfur, sulfur-containing silane coupling agents, and sulfur-containing vulcanization accelerators.

4. The rubber composition according to claim 1, wherein the white filler is silica, the sulfur-containing compound contains at least a sulfur-containing silane coupling agent, and an amount of the sulfur-containing silane coupling agent is from 1 to 15 parts by mass per 100 parts by mass of the diene rubber.

5. A pneumatic tire produced by using the rubber composition described in claim 1.

6. The pneumatic tire according to claim 5, wherein the rubber composition is used in at least one type selected from the group consisting of a cap tread, sidewall, belt, inner liner, carcass, and bead.
